(19) United States
(12) Patent Application Publication
(10) Pub. No.: US 2007/0210981 A1
(43) Pub. Date: Sep. 13, 2007

(54) Automatic address dispatch method for control of a plurality of light emitting units

(76) Inventors: Chien-wen Chung, Tainan City (TW); Chia-Li Lin, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/369,827

(22) Filed: Mar. 8, 2006

(51) Int. Cl. G09G 5/00

(52) U.S. Cl. 345/1.1

(57) ABSTRACT

An automatic address dispatch method for control of a plurality of light emitting units includes the following steps, Step 1: installing a server having a network float address protocol; Step 2: providing a light emitting device with the same network float address protocol as that of the server; Step 3: the server being connected to one or a plurality of the light emitting device via a network; Step 4: the server automatically dispatching a unique address to each light emitting device on the network according to the network float address protocol; Step 5: the server relatively controlling the response of each light emitting device on network by the unique address.

### BACKGROUND OF THE INVENTION

(a) Field of the Invention

The present invention relates to an automatic address dispatch method to control a plurality of light emitting units, and more particularly, to a method of utilizing a network float address protocol to control a plurality of light emitting units through a network configuration.

(b) Description of the Prior Art

Whereas light emitting devices usually operating in building, community and home operate Off/On by means of a switching installation, immediate detection for replacement is prevented in case of any damaged light emitting device to become a blind spot in the service works. Periodical inspection requires a considerable size of service crew. As a result, the maintenance of light emitting device consumes lot of workforce and expenses without time efficiency and at slower pace of service.

In the prior art, Color Kinetics' Colorcast 14 LED receives data with a Data Enabler, which is an installation for receiving DMX or Color Kinetics' lighting system management (LSM) formatted according to Ethernet Protocol. Each Data Enable supports 70 units of Colorcast 14 controlled by Color Kinetics controller series (including Color Kinetics LSM software). Associate arts have been disclosed in U.S. Pat. Nos. 6,016,038, 6,150,774, 6,340,865, and 6,788,011. However, these prior arts cited are found with the following flaws:

1. 250 Kpbs transmission rate is comparatively lower.

2. Only 512 channels are available for data transmission.

3. Absence of error detecting function. The address for each lighting fixture must be separately set.

4. Installation of additional repeater is required in case of more than 32 units of lighting fixture or longer range are served.

5. There are only up to three transmission lines are available.

### SUMMARY OF THE INVENTION

The primary purpose of the present invention is to provide a method of automatic address dispatch for the control of a plurality of light emitting units to solve the problem of limited type of link of network controlled lighting fixtures and limited quantity subject to the network controlled lighting fixtures of the prior art.

To achieve the purpose, the present invention comprises the following steps, Step 1: installing a server having a network float address protocol; Step 2: providing a light emitting device with the same network float address protocol as that of the server; Step 3, the server being connected to one or a plurality of the light emitting device via a network; Step 4: the server automatically dispatching a unique address to each light emitting device on the network according to the network float address protocol; Step 5: the server relatively controlling the response of each light emitting device on network by the unique address.

The dispatch of the unique address to each light emitting device on network by the server also applies to any new or replacement of light emitting device included in the network and provided with the network float address protocol.

The network is an area network or Internet. The network includes both the area network and the Internet at the same time. The network is separately connected to a display unit and the server transmits specific message to the display unit.

The present invention provides the following advantages:

1. Error Detection. The server will automatically dispatch a new address to the light emitting device replacing an existing one found in failure and the replacement of the light emitting device is also subject to the control of the server.

2. The present invention allows dynamic adjustment of transmission rate up to 10 Mbps.

3. The present invention also allows dynamic adjustment between 1 up to N channels depending on transmission rate or requirements.

4. The address may be automatically dispatched to any lighting fixture for connection as desired.

5. No repeater is needed if more than 32 units of light fixture are served.

6. Lighting fixtures may be connected in series, parallel, or series-parallel fashion to allow easier assembly.

7. The server easily controls the operations (including ON/OFF, lighting arrangement, color, color grade, color development sequence module and arrangement) of any lighting fixture.

8. The present invention controls the real-time status of the lighting fixtures through a display unit to correct any abnormality identified.

9. The present invention allows remote control.

### BRIEF DESCRIPTION OF THE DRAWINGS

FIG. 1 is a flow chart showing a process of a preferred embodiment of the present invention.

FIG. 2 is a schematic view showing the preferred embodiment of the present invention.

FIG. 3 is a schematic view showing a construction of a light emitting device used in the preferred embodiment of the present invention.

FIG. 4 is a schematic view of the present invention provided with a display unit.

FIG. 5 is a schematic view of the present invention provided with a communication unit.

### DETAILED DESCRIPTION OF THE PREFERRED EMBODIMENTS

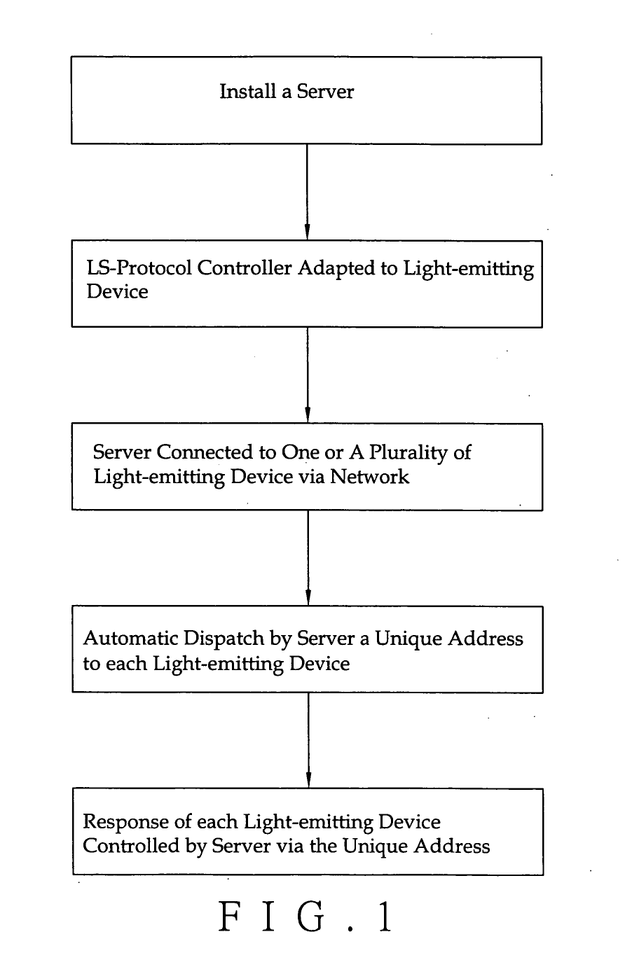

Referring to FIG. 1, the present invention includes the following steps:

Step 1: installing a server having a network float address protocol;

Step 2: providing a light emitting device with the same network float address protocol as that of the server;

Step 3: the server being connected to one or a plurality of the light emitting device via a network;

Step 4: the server automatically dispatching a unique address to each light emitting device on the network according to the network float address protocol.

Step 5: the server relatively controlling the response of each light emitting device on the network by the unique address.

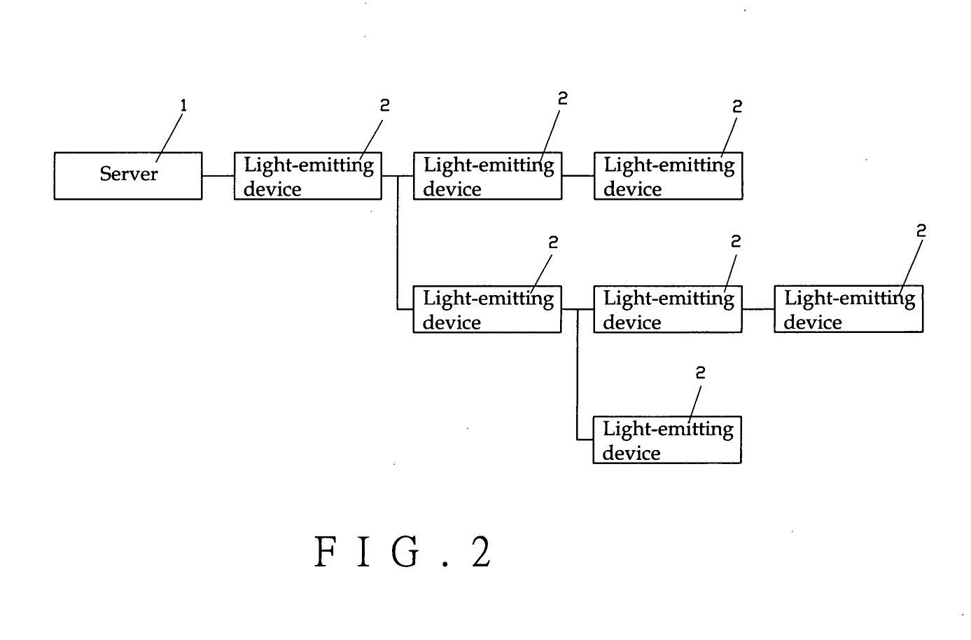

As illustrated in FIG. 2, one or a plurality of light emitting device (2) connected to a server (1) through cable or wireless network interface to form an area network. If multiple light-emitting devices (2) are provided, they are connected in series, parallel or series-parallel fashion to one another. Both the server (1) and the light emitting device (2) are provided with network float address protocol. With the network float address protocol, the server automatically dispatches a unique address to each light emitting device (2). Dispatching the address allows the server (1) immediate broadcast on the dedicated network once the light emitting device (2) is connected to the network of the server (1). Meanwhile, the server (1) executes the dispatch of the unique address to any newly connected light emitting device (2). The server (1) therefore controls each light emitting device (2) in the network by identifying the unique address. Through the network, the server (1) transmits power and controls each light emitting device (2).

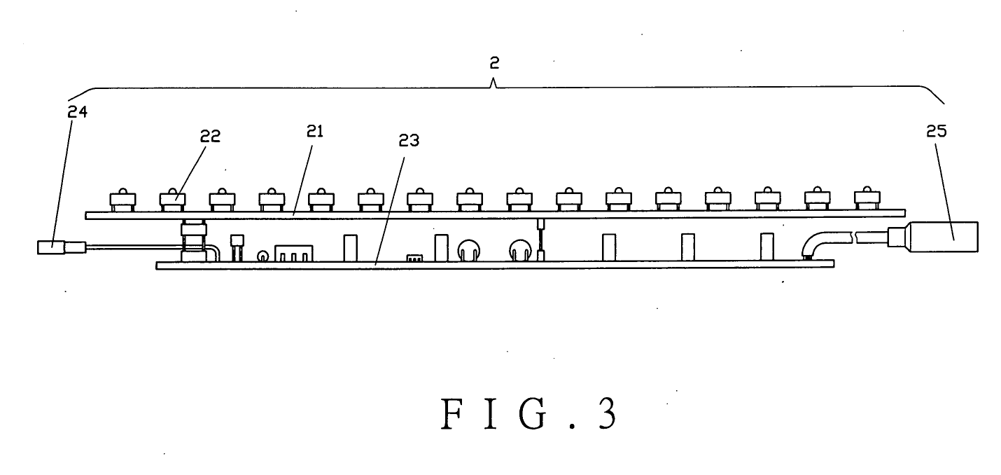

Now referring to FIG. 3, the light emitting device (2) includes a holder (21), a plurality of light emitting diodes (22), a control circuit (23), an input end (24), and an output end (25). The light emitting diodes (22) respectively in red, green, and blue are inserted to the holder (21). Each light emitting diode (22) is connected to the control circuit (23). The control circuit (23) is coupled to the input end (24) and the output end (25), respectively.

The server (1) controls the following responses of each light emitting device (2) by identification of address:

1. Controlling the ON/OFF of the light emitting diode (22) by taking advantage of current open and disconnection,

2. Controlling the light intensity of the light emitting diode (22) by taking advantage of the size of amperage,

3. Controlling the proportion of light intensity among three colors (red, green, and blue) of the light emitting diodes (22) to change the mix of colors and the arrangement of color development sequence module; and

4. Controlling the lapse of ON and OFF of the light emitting diode (22) to present flare or constant light mode.

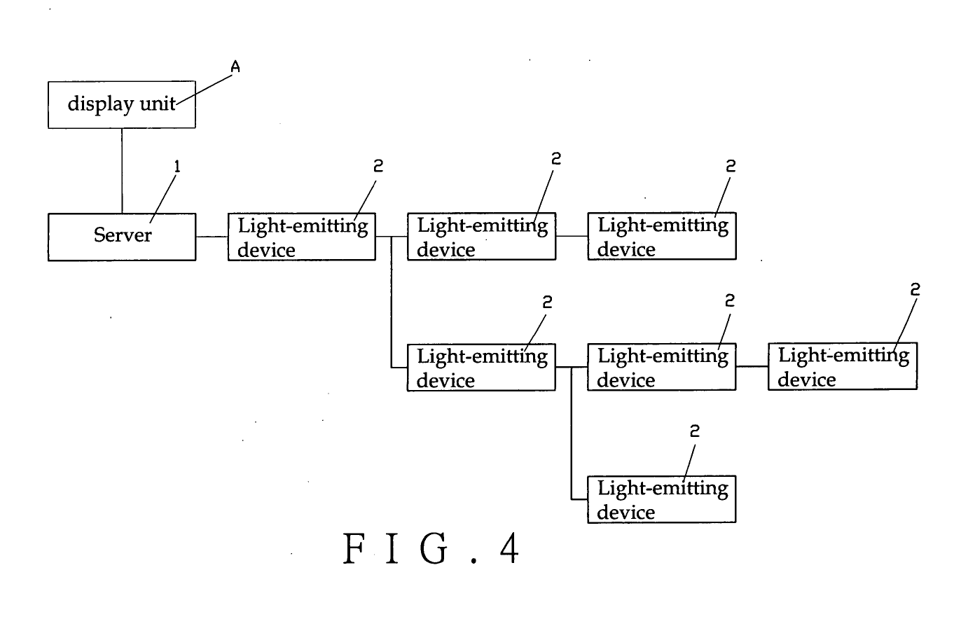

As illustrated in FIG. 4, a display unit (A) is separately connected to the network of the present invention to receive specific message transmitted from the server (1). In case of abnormality is found with any light emitting device (2), the server (1) receives the signals of the abnormality in the light emitting device (2) through the network and shows an alarm message through the display unit (A) to facilitate the manager to control the status of each light emitting device (2).

In mounting a new or additional light emitting device (2) in the network, a new and unique float address is automatically dispatched through the network float address protocol. Upon completing the dispatch of the unique address, the new light emitting device (2) is immediately subject to the control by the server (1). Again, the new light emitting device (2) may be connected to the existing light emitting devices (2) in series, parallel, or series-parallel fashion.

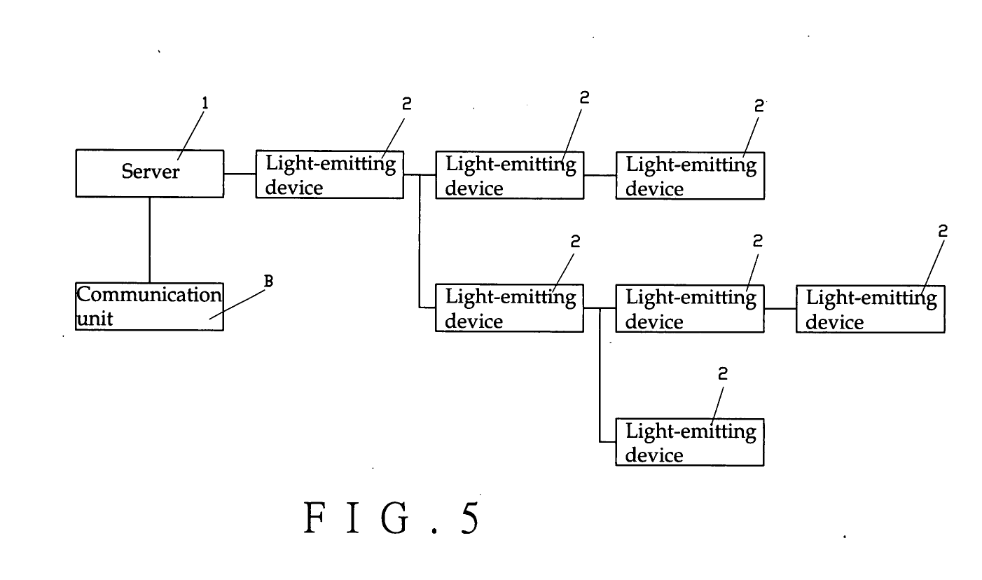

The area network of the present invention is further connected to another area network or Internet as illustrated in FIG. 5. The area network of the present invention is connected to a communication unit (B), e.g., network card or modem. The communication unit (B) is also connected to Internet. Accordingly, any remote facilities on Internet are enabled to execute remote controls including remote control, error detection, test, and updating over the server (1) when provided with an operation system and a control software corresponding to that of the server (1), thus to subject each light emitting device (2) to remote control. The remote facilities include PC, PDA, and telephone.

What is claimed is:

1. An automatic address dispatch method for control of a plurality of light emitting units, comprising the following steps:
Step 1: installing a server having a network float address protocol;
Step 2: providing a light emitting device with the same network float address protocol as that of the server;
Step 3: the server being connected to one or a plurality of the light emitting device via a network;
Step 4: the server automatically dispatching a unique address to each light emitting device on the network according to the network float address protocol;
Step 5: the server relatively controlling the response of each light emitting device on the network by the unique address.

2. The automatic address dispatch method for control of a plurality of light emitting units of claim 1, wherein the response of the light emitting device is On/Off.

3. The automatic address dispatch method for control of a plurality of light emitting units of claim 1, wherein the response of the light emitting device is light intensity.

4. The automatic address dispatch method for control of a plurality of light emitting units of claim 1, wherein the light emitting device includes red, green, and blue light emitting diodes and the response of the light emitting device is the proportion of light intensity among the red, green, and blue light emitting diodes.

5. The automatic address dispatch method for control of a plurality of light emitting units of claim 1, wherein the light emitting device includes red, green, and blue light emitting diodes and the response of the light emitting device is mixed light among the red, green, and blue light emitting diodes.

6. The automatic address dispatch method for control of a plurality of light emitting units of claim 1, wherein the response of the light emitting device is an arrangement of color development sequence module.

7. The automatic address dispatch method for control of a plurality of light emitting units of claim 1, wherein the response of the light emitting device is the lapse between On and Off.

8. The automatic address dispatch method for control of a plurality of light emitting units of claim 1, wherein the network is an area network.

9. The automatic address dispatch method for control of a plurality of light emitting units of claim 1, wherein the network is Internet.

10. The automatic address dispatch method for control of a plurality of light emitting units of claim 1, wherein the network includes an area network and Internet.

11. The automatic address dispatch method for control of a plurality of light emitting units of claim 1, wherein a display unit is connected to the network to receive specific message transmitted from the server.
